(19) United States
(12) Patent Application Publication
(10) Pub. No.: US 2024/0240760 A1
(43) Pub. Date: Jul. 18, 2024

(54) CRYOGENIC STORAGE SYSTEM

(71) Applicant: MAGNA STEYR Fahrzeugtechnik GmbH & Co KG, Graz (AT)

(72) Inventor: Guido BARTLOK, Graz (AT)

(73) Assignee: MAGNA STEYR Fahrzeugtechnik GmbH & Co KG, Graz (AT)

(21) Appl. No.: 18/533,562

(22) Filed: Dec. 8, 2023

(30) Foreign Application Priority Data
Jan. 13, 2023 (EP) 23151489.4

(51) Int. Cl. F17C 9/00; B60K 15/077; F17C 3/08

(52) U.S. Cl. CPC F17C 9/00; B60K 15/077; F17C 3/08; B60K 2015/03315

(57) ABSTRACT

A cryostorage system that includes a cryocontainer operable to store liquid hydrogen and/or gaseous hydrogen, the cryocontainer having an inner tank and an outer container, and at least one cryopump, operable to operate at low temperatures, arranged in the inner tank to be fully surrounded, during normal operation, by cryogenic fluid, the cryopump delivering liquid hydrogen and/or gaseous hydrogen in one or more stages to a consumer at a pressure greater than a pressure in the inner tank.

### CROSS-REFERENCE TO RELATED APPLICATIONS

The present application claims priority under 35 U.S.C. § 119 to European Patent Publication No. EP23151489.4 (filed on Jan. 13, 2023), which is hereby incorporated by reference in its complete entirety.

### TECHNICAL FIELD

One or more embodiments of the present disclosure relates to a cryostorage system comprising a cryocontainer for storing hydrogen, and particularly, a mobile cryostorage system for storing hydrogen to power a motor vehicle.

### BACKGROUND

It is known that mobile cryostorage systems are used to carry the hydrogen required to provide power in a motor vehicle.

For extraction from the storage container, the pressure in the interior thereof is increased, which is usually done by heating the container content, either with external energy or by a heat exchanger which is arranged in the inner tank of the storage container and through which gas that has already been vaporized flows.

The utility models Austrian Patent Publication Nos. AT 009 291 U1 and AT 010 015 U1 respectively disclose extraction devices which partially overcome the disadvantages associated with the conventional device in that the gaseous gas is returned by a pump and blown into the storage container, either into the gas space or into the liquid near to the bottom.

Alternatively, fluid delivery may be performed by a liquid pump with a linear drive and conditioning via a downstream heat exchanger, as is known from U.S. Patent Publication No. 2012317995A1.

Known solutions, however, have some disadvantages, for example:
In known solutions, the operating pressure in the inner tank must be greater than the supply pressure for the consumer. This reduces the usable storage capacity of the inner container since the density of the liquid gas at very low temperature decreases with an increasing pressure.
A greater normal working pressure in the inner tank reduces the pressure difference from the response pressure of the boil-off valve, i.e. the pressure build-up time is reduced.

With a passive system (closed inner tank heat exchanger), pressure build-up in the inner tank is possible only with simultaneous extraction for the consumer. This means in practice that after the filling, which takes place at a pressure below the operating pressure—only very small amounts of gas can initially be supplied to the consumer.
In an alternative concept, a so-called active system, a high-power blower is used, which is arranged outside the system and delivers warm hydrogen with a small pressure difference via a pipeline connection into the inner tank, and thereby increases the pressure level thereof independently of simultaneous extraction for the consumer. The blower and the required high-voltage electronics entail power consumptions in the kW range.

### SUMMARY

One or more embodiments of the present disclosure provides a cryostorage system of the aforementioned type, which reduces at least some of the aforementioned problems.

One or more embodiments of the present disclosure provides such a cryostorage system comprising a cryocontainer for storing hydrogen, which economically allows a favourable operating pressure in an inner tank and reliable extraction of the medium from the inner tank.

In accordance with the one or more embodiments, a cryostorage system comprises one or more of the following: a cryocontainer operable to store hydrogen, the cryocontainer having an inner tank and an outer container; at least one cryopump arranged in the inner tank of the cryocontainer, the cryopump being fully surrounded by cryogenic fluid during normal operation and/or a cryopump drive of the cryopump being operable to operate at very low temperatures, the cryopump delivering liquid hydrogen and/or gaseous hydrogen in one or more stages to a consumer at a pressure greater than the pressure in the inner tank.

In accordance with the one or more embodiments, a cryostorage system has at least one cryopump arranged in the inner tank of a cryocontainer. By way of the cryopump, liquid hydrogen and/or gaseous hydrogen can be extracted at very low temperature from the inner tank, and preferably, via a heat exchanger, which warms (i.e., increases the temperature) the hydrogen to be delivered to a consumer. The delivery to the consumer may in this case take place at a pressure which is greater than the pressure in the inner tank of the cryostorage system.

In accordance with the one or more embodiments, the cryopump is arranged in the inner tank of the cryocontainer, i.e., in a region of the cryostorage system which is at very low temperature during normal operation. The cryopump is therefore fully surrounded by cryogenic fluid during normal operation. The drive of the cryopump is operable to operate at very low temperatures.

The following advantages may be achieved by arranging a cryopump in the inner tank:
The operating pressure in the inner tank may be minimized and may be less than the lowest possible supply pressure of the consumer. A low operating pressure in the inner tank allows longer pressure build-up times or lower design pressures and therefore smaller wall thicknesses, i.e., lighter inner tanks or more complex storage container geometries may be produced. The back-gas losses during the liquid gas filling may be reduced by the lower inner tank pressure. The enhanced thermodynamic conditions in the inner tank allow greater filling rates. The change in the delivery level (delivery pressure), or the delivery quantity, is accelerated or facilitated. The energy consumption for the operation of the cryopump, which is entirely exposed to the cryogenic liquid temperature, is much less than for an active system with a blower or with pumps, or compressors, the drive and/or compression work of which is carried out approximately at ambient temperature. With a suitable configuration, liquid hydrogen and/or gaseous hydrogen may be selectively delivered. This allows adaptation between the extraction mass flow and the pressure reduction due to volume work.

In accordance with the one or more embodiments, via the cryopump, the hydrogen at very low temperature is preferentially supplied to a heat exchanger, which warms the hydrogen, and fed from the heat exchanger additional to the consumer.

In accordance with the one or more embodiments, the cryopump is operable to be in the vicinity of or otherwise adjacent to the bottom of the inner tank and is surrounded by liquid hydrogen during normal operation.

In accordance with the one or more embodiments, a gas extraction line is operable to be at least at one intake port of the cryopump, the open end of which gas extraction line is operable to be in the vicinity of the top of the inner tank, and/or gaseous hydrogen being situated at the open end of the gas extraction line during normal operation, so that, via the gas extraction line, gaseous hydrogen can be extracted from the inner tank by the cryopump. The gas extraction line is therefore operable so that gaseous hydrogen can be extracted from the inner tank via the gas extraction line. The gas extraction line may be designed as an extension of the intake port.

An additional extraction line or extraction opening for extraction of liquid may be operable to be at the same or at a different intake port of the cryopump.

In accordance with the one or more embodiments, gaseous hydrogen or liquid hydrogen may be selectively delivered at least at one intake port of the cryopump. Preferentially, a check valve for switching between gaseous hydrogen and liquid hydrogen is operable to be at the intake port of the cryopump. The check valve is preferably arranged in the vicinity of or otherwise adjacent to the cryopump and/or the intake port of the cryopump.

In accordance with the one or more embodiments, the cryopump comprises a linear pump which is operable to facilitate delivery on both sides. The left delivery flow and/or the right delivery flow of the linear pump is operable selectively to deliver gas or liquid, preferentially via a check valve near to the pump for switching between gaseous and liquid hydrogen, i.e. from LH₂ (liquid hydrogen) to GH₂ (gaseous hydrogen).

In accordance with the one or more embodiments, the cryocontainer is operable so that a partial flow of the warmed hydrogen, i.e., the extracted hydrogen downstream of the heat exchanger, can be returned via a gas return line into the inner tank in order to increase the inner tank pressure and preferentially maintain it at a minimum pressure. Preferably, a check valve for the gas return to the inner tank is arranged in the gas return line.

In accordance with the one or more embodiments, a pressure reducer, preferentially with a downstream pressure safety valve, is installed in the gas return line for the gas return to the inner tank. In this way, the pressure for the gas return into the inner tank may be limited.

In accordance with the one or more embodiments, a buffer container for warm hydrogen is arranged between the cryopump and the consumer. In this way, it is possible to compensate for a fluctuating delivery power of the cryopump possibly occurring.

In accordance with the one or more embodiments, a spring-loaded non-return valve or a shuttle valve is arranged in a pressure line of the cryopump, which takes off the delivered medium, so that the pressure line which takes off the delivered medium joins at the spring-loaded non-return valve or at the shuttle valve with an inlet line into the inner tank.

In accordance with the one or more embodiments, the inner tank is fillable via a filling interface, the filling preferentially taking place at least in part via an extraction line and the spring-loaded non-return valve or the shuttle valve and the inlet line into the inner tank.

In accordance with the one or more embodiments, the shuttle valve has an integrated float, the inherent weight of the float keeping the float in a lower end position during filling so that the inlet line for filling the inner tank is uncovered. When the cryopump is started, the float is raised by the delivery flow so that it blocks the inlet line to the inner tank and the delivery flow is pumped only to the consumer.

### DRAWINGS

One or more embodiments of the present disclosure will be illustrated by way of example in the drawings and explained in the description hereinbelow.

FIG. 1 illustrates a schematic representation of a cryostorage system, in accordance with one or more embodiments.

FIG. 2 illustrates a schematic representation of a part of the cryostorage system of FIG. 1 in an alternative embodiment.

FIG. 3 illustrates a schematic representation of a part of the cryostorage system of FIG. 1 in another alternative embodiment.

FIG. 4 illustrates a schematic representation of an alternative embodiment of a cryostorage system, in accordance with one or more embodiments.

FIG. 5 illustrates a schematic representation of a second alternative embodiment of a cryostorage system, in accordance with one or more embodiments.

FIG. 6 illustrates a schematic representation of a third alternative embodiment of a cryostorage system, in accordance with one or more embodiments.

FIG. 7 illustrates a schematic representation of a detail of a shuttle valve of the cryostorage system of FIG. 6 in a first state.

FIG. 8 illustrates a schematic representation of a detail of a shuttle valve of a cryostorage system of FIG. 6 in a second state.

### DESCRIPTION

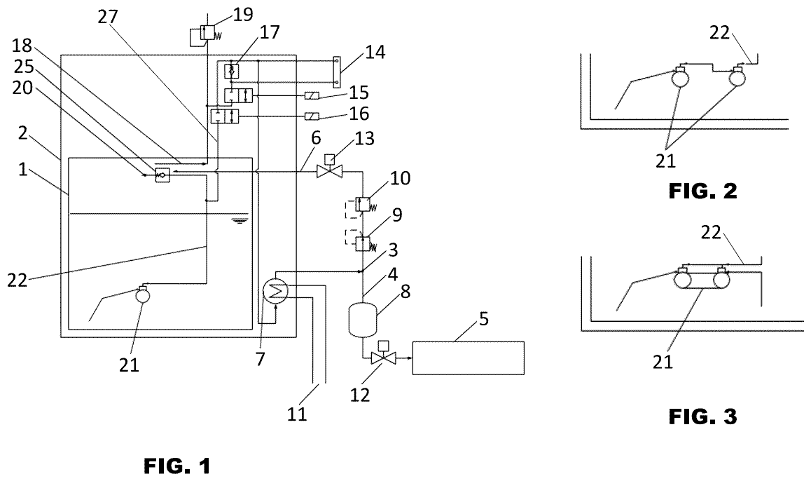

FIG. 1 represents a cryostorage system in accordance with one or more embodiments, which comprises a cryocontainer having an inner tank 1, an outer container 2, and an insulation space serving as an intermediate space between the inner tank 1 and the outer container 2. The cryostorage system is operable to deliver cryogenic liquid at very low temperature from the inner tank 1 via a power-controlled pressure-increasing cryopump 21 and a pressure line 22 of the cryopump, which joins with an extraction line 27 and debouches at a line connection 3 into a supply line 4, to a consumer 5.

The cryopump 21 is fully surrounded by cryogenic fluid, i.e., a cryopump drive of the cryopump 21 also operates at very low temperatures, which allows a low electrical power consumption for the cold gas compression. The cryopump 21 is arranged near to the bottom of the inner tank 1 and is fully surrounded by liquid hydrogen.

From the inner tank 1 into the extraction line 27, furthermore, gas can flow by opening a GH₂ tank valve 15 and/or liquid can flow by opening an LH₂ tank valve 16. Gas may in this case be extracted from the inner tank 1 via a combined safety and gas extraction line 18. A non-return valve 17 for the gas extraction may be provided downstream of the GH₂ tank valve 15. Gas may also be let out from the combined safety and gas extraction line 18 through a pressure relief safety valve 19.

Downstream of the extraction from the inner tank 1, in particular, downstream of the cryopump 21 and downstream of the GH₂ tank valve 15 and the LH₂ tank valve 16, the cryogenic fluid is fed through a heat exchanger 7 while being fully converted into the gas phase by supplying heat, preferably via cooling water 11 of the consumer 5, and at the same time warmed sufficiently for the consumer 5. The cryopump 21 delivers the hydrogen on demand to the consumer 5 at a greater pressure than in the inner tank 1. The extraction of fuel from the cryostorage system reduces the pressure and the amount of fuel in the inner tank 1 thereof.

In order to compensate for a fluctuating delivery power of the cryopump 21 possibly occurring, a buffer container 8 for warm hydrogen may additionally be arranged between the pump 21 and the consumer 5, particularly in the supply line 4. A check valve 12 for the H₂ supply to the consumer 5 may be arranged in the supply line 4 upstream of the consumer 5.

The cryostorage system is fillable via a filling interface 14. The filling may take place in part via the extraction line 27 and an LH₂ inlet line 20 into the inner tank 1.

A spring-loaded non-return valve 25 (FIGS. 1 to 5) or a shuttle valve 26 (FIGS. 6 to 8) may be arranged in the pressure line 22 of the cryopump 21, which takes off the delivered medium, so that the pressure line 22 taking off the delivered medium joins at the spring-loaded non-return valve 25 or at the shuttle valve 26 with an inlet line 20 into the inner tank 1. The filling may then take place via the extraction line 27 and via the spring-loaded non-return valve 25 or the shuttle valve 26 and via the inlet line 20 into the inner tank 1.

Should there be a need to increase or maintain the pressure in the inner tank 1 of the cryostorage system, gas may be transferred back into the inner tank 1 via a valve 13 in a gas return line 6, which branches off at the line connection 3 from the extraction line 27 downstream of the heat exchanger 7. In order to limit the pressure for the gas return into the inner tank 1, a pressure reducer 9 with a downstream pressure safety valve 10 may if required be installed in the gas return line 6.

Whereas FIG. 1 shows a one-stage pressure increase with gas return, FIG. 2 shows an alternative embodiment having a series pump arrangement for a two-stage pressure increase with gas return.

Should there be a need for very high supply pressures (supercritical, for example, greater than 20 bar), at least one additional cryopump stage may be connected in series downstream of the first cryopump stage (cf. FIG. 2). In this case, the final pressure of the first cryopump 21 becomes the intake pressure of the second cryopump 21. The series interconnection allows greater final pressures together with a low energy consumption for the compression of the cold gas. Alternatively, a cryopump 21 and the heat exchanger 7 may also be followed by a warm compressor outside the tank system for the final compression.

FIG. 3 shows an alternative embodiment of the pump instead of the delivery pump, in the form of a linearly driven cryopump 21 displacing on both sides, having two opposite displacement working spaces each with a separate intake and outlet port for fluid delivery on both sides. The cryopump 21 is therefore operable as a linear pump which delivers the stored medium on both sides, in FIG. 3 only in the form of the liquid medium.

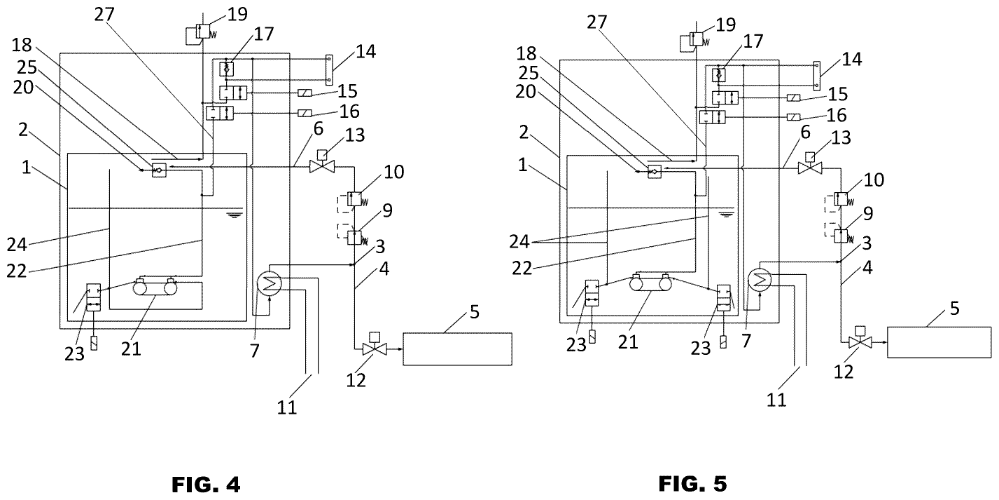

FIG. 4 shows an alternative embodiment of a linearly driven cryopump 21 displacing on both sides with separate intake ports (as in FIG. 3), a check valve 23, on one side (in FIG. 4 on the left side of the linear delivery pump), being operable for the selective delivery of liquid or gas. A gas extraction line 24 is operable to be at this intake port of the cryopump 21, the open end of which gas extraction line is operable to be in the vicinity of the top of the inner tank 1, and gaseous hydrogen being situated at the open end of the gas extraction line 24 during normal operation, so that, via the gas extraction line 24, gaseous hydrogen can be extracted from the inner tank 1 by the cryopump 21. Only a liquid delivery takes place on the opposite second side of the pump. In other regards, the cryostorage system is operable in the same way as the variants of FIGS. 1 to 3.

Embodiments of a cryostorage system having a cryopump 21 which is not operable as a linear delivery pump, such as illustrated for example in FIGS. 1 to 3, may also comprise such a gas extraction line 24 and/or such a check valve 23 for the selective delivery of liquid or gas.

By incorporating additional equipment in the inner tank (cryovalve(s), pipeline(s)), gas or liquid may selectively flow to the respective intake port by a controlled alternate valve switching setting. By the valve controller 23, for example in FIG. 4, the ratio of gas to liquid extraction can be varied and therefore the ratio of mass flow to the consumer 5 to the pressure reduction in the inner tank 1 may therefore also be varied. The possibility of selection between gas or liquid extraction offers an additional degree of freedom since the ratio of mass flow to the consumer 5 to the pressure reduction in the inner tank 1 is therefore no longer approximately constant and the respective quantity may be varied not only via the pump frequency, but in each case flexibly.

When the valve 23 is open, LH₂ floods the tube as far as the intake port of the cryopump 21 and the gas extraction line 24 up to the height of the LH₂ level (as a consequence of the hydrostatic equilibration). If the valve 23 is closed, firstly the residual LH₂ is delivered from the pipeline of the intake port before gaseous hydrogen flows in from above through the gas extraction line 24 to the intake port.

Gas can therefore be extracted from the inner tank 1 via a gas extraction line 24 as an extended intake port of the cryopump 21. Liquid or gas can selectively be delivered from the inner tank 1 by the pump 21 through a check valve 23 near to the pump for switching from LH₂ to GH₂.

Should a linear pump (FIGS. 3 to 6), which delivers on both sides, be used, there are different possible variants for the extraction: The left and right delivery flows may for example both deliver only LH₂, i.e. liquid hydrogen, or one of the two sides, for example the left side, may selectively deliver GH₂ or LH₂ and the other side may deliver only LH₂, or both sides may selectively deliver GH₂ or LH₂, i.e., gas or liquid, so that the medium delivered is variable overall from 100% GH₂ to 100% LH₂ delivery.

FIG. 4 shows an alternative embodiment of these possibilities with a linearly driven cryopump 21 displacing on both sides with a connected intake port, with selective delivery of liquid or gas on one side, namely in this case the left side, of the pump.

FIG. 5 shows a variant of a linearly driven cryopump 21 displacing on both sides with separate intake ports, both of which are operable selectively for the delivery of liquid and/or gas. A check valve 23 for switching from LH₂ to GH₂ is respectively arranged on each of the two intake ports of the cryopump 21.

In the arrangements described so far, a spring-loaded non-return valve 25 in the filling line in the inner tank in each case allows filling while circumventing the pump 21, and preferentially into the gas space. In this case, for opening the spring-loaded non-return valve 25, it is necessary for the filling pressure to be greater than the maximum delivery pressure of the cryopump 21. Although the non-return valve 25 creates an additional flow resistance for the filling, it avoids one for the delivery flow of the cryopump 21 to the consumer 5.

FIG. 6 shows another configuration of the valves for the filling, namely a shuttle valve 26 in the inner tank 1, here with a float position for extraction by the cryopump 21—instead of the spring-loaded non-return valve 25.

The shuttle valve 26 with an integrated float 28 (cf. FIGS. 6 to 8) represents an alternative embodiment for this function, of the switching between extraction and filling. The shuttle valve 26 is arranged at the connecting point between the pressure line 22, the extraction line 27 and the inlet line 20 into the inner tank 1.

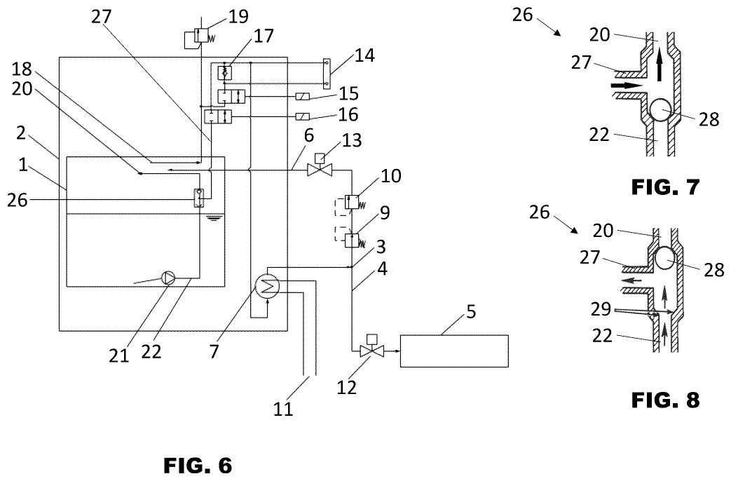

During filling (FIG. 7), the float 28 remains in the lower end position due to its inherent weight and uncovers the inlet line 20 for filling the inner tank. By starting the cryopump 21, the float 28 is raised/moved by the delivery flow in such a way that it blocks the inlet of the filling line to the inner tank 1, i.e. the inlet line 20 (FIG. 8), so that the delivery flow is pumped only to the consumer 5.

The advantages of this alternative are that the filling can be performed with a lower flow resistance and the filling pressure and maximum delivery pressure of the cryopump 21 are independent of one another. However, the float 28 integrated in the shuttle valve 26 creates an additional flow resistance for the delivery flow of the cryopump 21 to the consumer 5.

Both configurations of this device allow pressure relief of the adjacent lines and of the cryopump 21 into the inner tank 1 when contained fluid expands by warming.

FIG. 7 therefore shows the flow in the shuttle valve 26 during filling. The inherent weight of the float 28 keeps the float 28 in a lower end position during filling, so that the inlet line 20 for filling the inner tank 1 is uncovered.

FIG. 8 shows the flow in the shuttle valve 26 during extraction via the cryopump 21. When the cryopump 21 is started, the float 28 is raised from the valve seat 29 by the delivery flow, so that it blocks the inlet line 20 to the inner tank 1 and the delivery flow is pumped only to the consumer 5.

The terms “coupled,” “attached,” or “connected” may be used herein to refer to any type of relationship, direct or indirect, between the components in question, and may apply to electrical, mechanical, fluid, thermal, optical, electromagnetic, electromechanical, or other connections. In addition, the terms “first,” “second,” etc. are used herein only to facilitate discussion, and carry no particular temporal or chronological significance unless otherwise indicated.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

### LIST OF REFERENCE SIGNS

1 inner tank of the cryostorage system
2 outer container
3 line connection
4 supply line
5 consumer
6 gas return line
7 heat exchanger
8 buffer container
9 pressure reducer
10 pressure safety valve
11 cooling water circuit
12 check valve for H₂ supply to the consumer
13 check valve for gas return to the inner tank
14 interface for filling
15 GH₂ tank valve
16 LH₂ tank valve
17 non-return valve for the gas extraction
18 combined safety and gas extraction line
19 pressure relief safety valve
20 LH₂ inlet line into the inner tank
21 cryopump(s)
22 pressure line of the cryopump
23 check valve close to the pump for switching from LH₂ to GH₂
24 gas extraction line as extended intake port of the cryopump
25 additional non-return valve
26 shuttle valve
27 extraction line
28 float
29 valve seat

What is claimed is:

1. A cryostorage system, comprising:
a cryocontainer operable to store liquid hydrogen and/or gaseous hydrogen, the cryocontainer having an inner tank and an outer container; and
at least one cryopump, operable to operate at low temperatures, arranged in the inner tank to be fully surrounded, during normal operation, by cryogenic fluid, the cryopump delivering liquid hydrogen and/or gaseous hydrogen in one or more stages to a consumer at a pressure greater than a pressure in the inner tank.

2. The cryostorage system of claim 1, further comprising a gas extraction line operable to serve as at least at one intake port of the cryopump.

3. The cryostorage system of claim 2, wherein the gas extraction line has an open end arranged adjacent to a top region of the inner tank to facilitate an extraction of gaseous hydrogen from the inner tank by the cryopump.

4. The cryostorage system of claim 2, further comprising a check valve to facilitate switching between liquid hydrogen and/or gaseous hydrogen for a selective delivery of the liquid hydrogen and/or gaseous hydrogen at the least at one intake port of the cryopump.

5. The cryostorage system of claim 1, wherein the cryopump comprises a linear pump operable to deliver liquid hydrogen and/or gaseous hydrogen on both sides thereof.

6. The cryostorage system of claim 5, further comprising a check valve to facilitate selective delivery of the liquid hydrogen and/or gaseous hydrogen by the linear pump.

7. The cryostorage system of claim 1, further comprising a heat exchanger to warm the liquid hydrogen and/or gaseous hydrogen.

8. The cryostorage system of claim 7, further comprising a gas return line operable to facilitate return of a partial flow of extracted gaseous hydrogen downstream of the heat exchanger into the inner tank to increase the inner tank pressure.

9. The cryostorage system of claim 8, further comprising a pressure reducer having downstream pressure safety valve arranged in the gas return line for the return of the extracted gaseous hydrogen to the inner tank.

10. The cryostorage system of claim 1, further comprising a buffer container, arranged between the cryopump and the consumer, operable to receive heated hydrogen.

11. The cryostorage system of claim 1, further comprising a spring-loaded non-return valve or a shuttle valve arranged in a pressure line of the cryopump, which takes off delivered liquid hydrogen and/or gaseous hydrogen, so that the pressure line joins at the spring-loaded non-return valve or at the shuttle valve with an inlet line into the inner tank.

12. The cryostorage system of claim 11, further comprising a filling interface to facilitate, via an extraction line, the spring-loaded non-return valve or the shuttle valve, filling of the inner tank.

13. The cryostorage system of claim 12, wherein the shuttle valve has an integrated float maintained in a lower end position so that the inlet line for filling the inner tank is uncovered.

14. The cryostorage system of claim 13, wherein the float is raised to a blocking position to block the inlet line to the inner tank to facilitate delivery of the liquid hydrogen and/or gaseous hydrogen only to the consumer.

15. The cryostorage system of claim 14, wherein the float is raised to the blocking position by delivery flow of the liquid hydrogen and/or gaseous hydrogen during operation of the cryopump.

16. A cryostorage system, comprising:
a cryocontainer operable to store liquid hydrogen and/or gaseous hydrogen, the cryocontainer having an inner tank and an outer container; and
at least one cryopump, operable to operate at low temperatures, having a cryopump drive arranged in the inner tank to be fully surrounded, during normal operation, by cryogenic fluid, the cryopump delivering liquid hydrogen and/or gaseous hydrogen in one or more stages to a consumer at a pressure greater than a pressure in the inner tank.

17. The cryostorage system of claim 16, further comprising a gas extraction line operable to serve as at least at one intake port of the cryopump.

18. The cryostorage system of claim 17, wherein the gas extraction line has an open end arranged adjacent to a top region of the inner tank to facilitate an extraction of gaseous hydrogen from the inner tank by the cryopump.

19. The cryostorage system of claim 17, further comprising a check valve to facilitate switching between liquid hydrogen and/or gaseous hydrogen for a selective delivery of the liquid hydrogen and/or gaseous hydrogen at the least at one intake port of the cryopump.

20. The cryostorage system of claim 16, wherein the cryopump comprises a linear pump operable to deliver liquid hydrogen and/or gaseous hydrogen on both sides thereof.
